(19) United States
(12) Patent Application Publication
(10) Pub. No.: US 2011/0139705 A1
(43) Pub. Date: Jun. 16, 2011

(54) Apparatus for maintaining a water level in a dry filter tank or a fish tank

(76) Inventor: Gus Stampelos, Saint James, NY (US)

(21) Appl. No.: 12/653,621

(22) Filed: Dec. 16, 2009

(51) Int. Cl. B01D 35/04

(52) U.S. Cl. 210/432

(57) ABSTRACT

Apparatus for use in combination with a conventional dry filter tank or fish tank for maintaining a predetermined water level without the use of electric motors or pumps. One apparatus comprises at least one container for holding a supply of water having a mouth portion and a dispensing opening, and a support for supporting the container in an inverted position over the tank. One such container has a vertically adjustable mouth portion. In one apparatus, the support is adjustable to fit over any size dry filter tank.

The present invention is directed to an apparatus for maintaining a water level in a dry filter tank used with a fish tank, or for directly maintaining a water level in a fish tank. More particularly, the present invention is directed to an apparatus positioned on top of a dry filter tank or a fish tank, which replenishes water without the need for electric motors or pumps.

### BACKGROUND OF INVENTION

Dry filter tanks are often used with fish tanks. A dry filter tank is a tank having a supply of water and a filter apparatus which is usually positioned near a fish tank to circulate and filter water from the main fish tank, cleaning the water and adding any chemicals in the process for a short period of time, e.g. a week or two. A dry filter tank typically needs to be replenished with water after a week or two. For longer periods of time, there are previously known devices for maintaining the water level in a dry filter tank or a fish tank which rely upon electric motors or pumps and which are therefore subject to equipment failure and power outages.

It would be desirable to provide an apparatus which can maintain a desired water level in a fish tank or a dry filter tank and which does not rely upon electrical equipment or electricity.

### SUMMARY OF INVENTION

Embodiments of the present invention are directed to apparatus for use with conventional dry filter tanks or conventional fish tanks. One embodiment of the present invention is directed to an apparatus for use in combination with a conventional dry filter tank having at least one opening. The apparatus of this embodiment comprises a container comprising a mouth portion having a dispensing opening. The mouth portion comprises a valve selectively operable to prevent or allow water to flow from the dispensing opening. The apparatus further comprises at least one support for supporting the container in an inverted position on the dry filter tank with the dispensing opening positioned at a predetermined water level in the dry filter tank.

According to another embodiment of the present invention, the vertical position of the dispensing opening on the mouth portion of the container is adjustable.

In another embodiment of the present invention, the apparatus is used in combination with a fish tank. In this embodiment, the container is positioned on a support with the dispensing opening facing downwardly and the mouth portion extending at least partially directly into an opening of a fish tank. The container and the support are preferably positioned within a housing above the fish tank.

In yet another embodiment of the present invention, an adjustable support is positioned on a conventional dry filter tank or fish tank. In this embodiment, the adjustable support comprises a container support portion that receives a container and a plurality of adjustable arms.

Another embodiment of the present invention does not include a support for supporting the container. The container is positioned directly on the dry filter tank in an inverted position. The container and the dry filter tank are optionally positioned within a housing.

The apparatus of the present invention maintains a predetermined water level in a dry filter tank or in a fish tank on a continuous basis without the use of electric motors or pumps. This allows a fish tank owner to go away on vacation for an extended period without worrying about the level of water in the dry filter tank or the fish tank.

### BRIEF DESCRIPTION OF THE DRAWINGS

FIG. 1 is a perspective view of one embodiment of the present invention;

FIG. 2 is a close-up view of a portion of FIG. 1;

FIG. 3 is a rear perspective view of a portion of FIG. 1;

FIG. 4 is a perspective view of a container of the embodiment illustrated in FIG. 3;

FIG. 5 is a perspective view of a support of the embodiment illustrated in FIG. 3;

FIG. 6 is a perspective view of a support of an alternative embodiment of the present invention;

FIG. 7 is a front view of an alternate container and alternate support of the present invention;

FIG. 8 is a top view of the container and support illustrated in FIG. 7;

FIG. 9 is a close-up view of the embodiment illustrated in FIG. 7;

FIG. 10 is a front view of another embodiment of the present invention.

### DETAILED DESCRIPTION

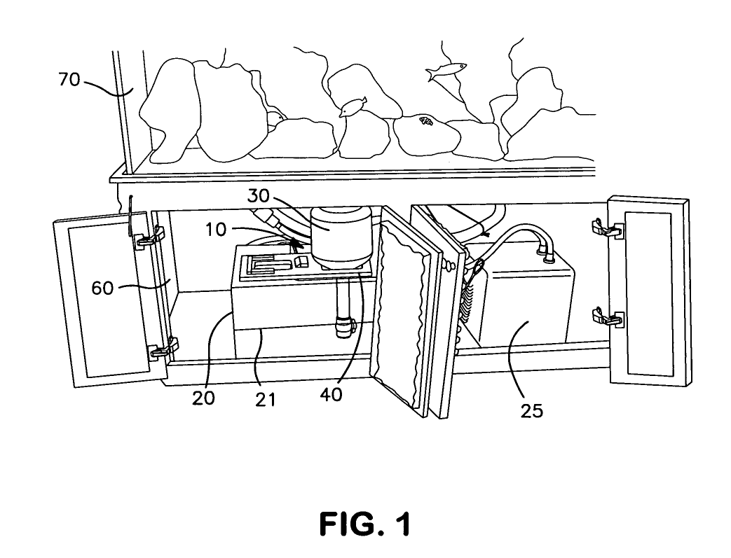

Various embodiments of the present invention are directed to apparatus for use in maintaining a predetermined water level in a dry filter tank or directly in a fish tank. According to one embodiment of the present invention, as illustrated in FIG. 1, the apparatus 10 is used in combination with a dry filter tank 20. The dry filter tank 20 holds a predetermined quantity of water, a filtering device, a pump motor, and optionally other equipment such as an ionizer, a heater, and/or a water cooler 25 to maintain desired water quality and temperature. In order for a dry filter tank to operate properly and avoid pump failure, a minimum level of water is required in the dry filter tank 20. The dry filter tank is therefore initially filled to a predetermined water level 21, which is at least as high as the minimum required level and preferably high enough so that daily replenishing of the water in the dry filter tank is not required. Normal daily evaporation will tend to lower the water level. The dry filter tank can have a completely open top and preferably has at least one upper opening.

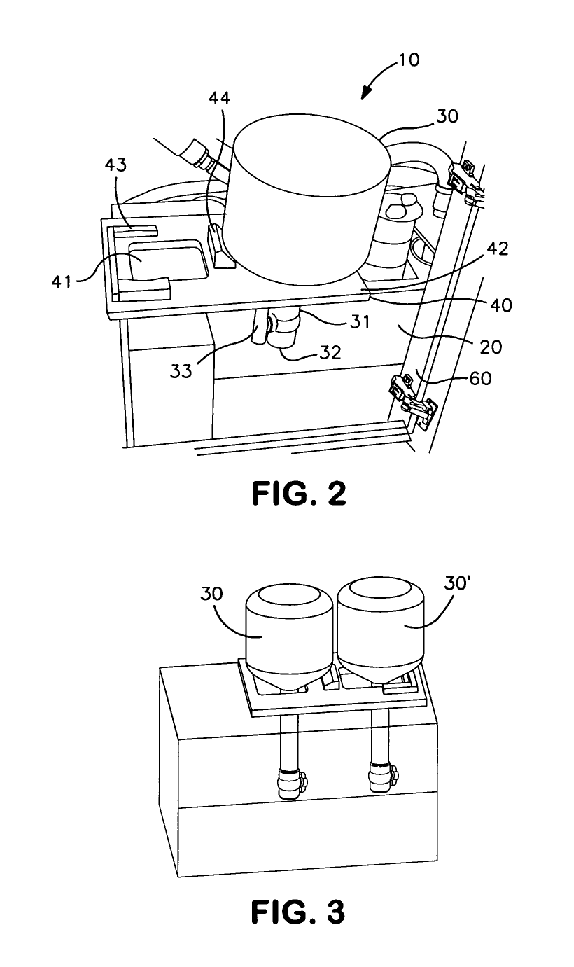

The apparatus 10 comprises a container 30 which holds a supply of water. The container 30 functions as a replenisher tank for replacing the water in the dry filter tank 20. In the embodiment illustrated in FIGS. 1-5, the container 30 is cylindrical and is similar to the shape of a 3 or 5-gallon water bottle typically used with a conventional water cooler. Other shapes and sizes can be utilized without departing from the scope of the present invention. For an aquarium having a higher evaporation rate, a larger container is preferred.

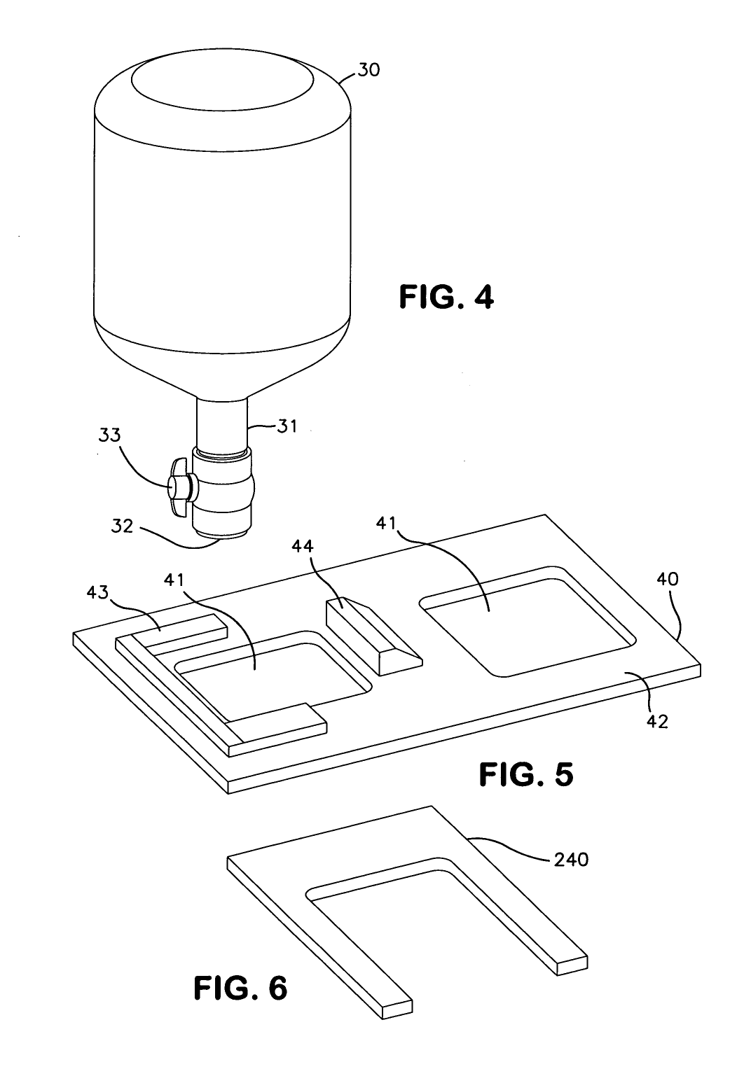

As best illustrated in FIG. 4, the container 30 comprises a mouth portion 31 having a dispensing opening 32. The mouth portion 31 further comprises a valve 33 which is selectively operable to be opened and closed to either allow or prevent a flow of water from the container 30. The valve 33 is preferably manually controlled. In use, the valve 33 is preferably closed when the container 30 is being positioned over the dry filter tank 20. The valve 33 is then opened after the container 30 has been properly positioned over the dry filter tank in an inverted position. In this embodiment, the valve 33 is a ball valve which is threadedly connected to the mouth portion 31. The valve 33 can be connected to the mouth portion 31 in any known manner such as pressure fit with a sealant, e.g. a silicone sealant. Other types of valves can be utilized. According to the various embodiments, the valve can be integrally formed or separately formed with other parts of the container and then assembled.

The apparatus 10 of this embodiment further comprises a support 40 for supporting the container 30 in an inverted position over the dry filter tank 20. As illustrated in FIG. 5, support 40 is a dual support structure which advantageously supports two containers in an inverted position over the dry filter 20. The support 40 comprises two substantially rectangular openings 41, a generally flat bottom surface and a top surface 42. One of the openings 41 receives container 30. The openings 41 are large enough to allow the mouth portion 31 to pass through opening 41 and extend at least partially into the dry filter tank 20. While the openings 41 in this illustrated embodiment are the same shape, the openings can have different shapes. Similarly, while the openings 41 in the illustrated embodiment are different sizes, the openings can be the same size.

A plurality of positioning segments 43 and 44 extend upwardly from the top surface 42 to enhance the support of the containers. Preferably, upper portions of the positioning segments 43, 44 which contact the container 30 are beveled to better support the container 30. In this illustrated embodiment, the positioning segment 43 is positioned proximate at least a portion of a perimeter of one of the rectangular openings 41. As illustrated in FIG. 3, positioning segment 44 is between the two openings 41 to support both container 30 on the left and a second container 30′ on the right.

The illustrated support 40 is positioned on the dry filter tank 20. The container 30, preferably with the valve 33 closed, is positioned on the support 40 in an inverted position so that the dispensing opening 32 is facing downwardly and positioned at the desired water level. In this assembled configuration, the mouth portion 31 of container 30 extends at least partially into dry filter tank 20 and the dispensing opening 32 is at the predetermined minimum water level 21. This may be above or below the existing water level when the container is initially placed above the tank.

While the illustrated support 40 is useful with existing tanks, supports manufactured in the future can be permanently connected to a tank. According to another embodiment, the container can be permanently connected to the support. According to another embodiment, the support is positioned over and spaced from the dry filter tank, i.e. the support itself does not contact the dry filter tank.

The container 30 serves as a reservoir which replenishes water to the dry filter tank 20 when the water level in dry filter tank 20 decreases so that desired minimum water level 21 in the dry filter tank 20 is maintained. As the water level in the dry filter tank 20 decreases, e.g., due to evaporation from the system, to a point below dispensing opening 32, air enters the dispensing opening 32 and allows water to flow from the container 30 into the dry filter tank 20. Water from the container 30 continues to flow into the dry filter tank 20 until the water in the dry filter tank 20 reaches the level of the dispensing opening 32, i.e. until further flow of air into container 30 is prevented by water in tank 20. Flow from the container 30 will then cease since the discharge of water only occurs as air is permitted to enter the dispensing opening 32. The remaining water in container 30 will be maintained in the container 30 until the water level in the dry filter tank 20 again falls below the level of the dispensing opening 32. Thus, the water level in the dry filter tank is maintained at the level of the dispensing opening 32.

The dry filter tank 20 is preferably underneath a fish tank and inside a housing such as an aquarium stand. The dry filter tank 20 is operatively connected to the fish tank to filter water supplied from the fish tank and to replenish water in the fish tank lost due evaporation.

According to another embodiment, the support is positioned over the dry filter and does not contact the dry filter.

FIG. 6 illustrates an alternative support 240 which supports only one container. Support 240 generally comprises a generally flat bottom surface and a top surface.

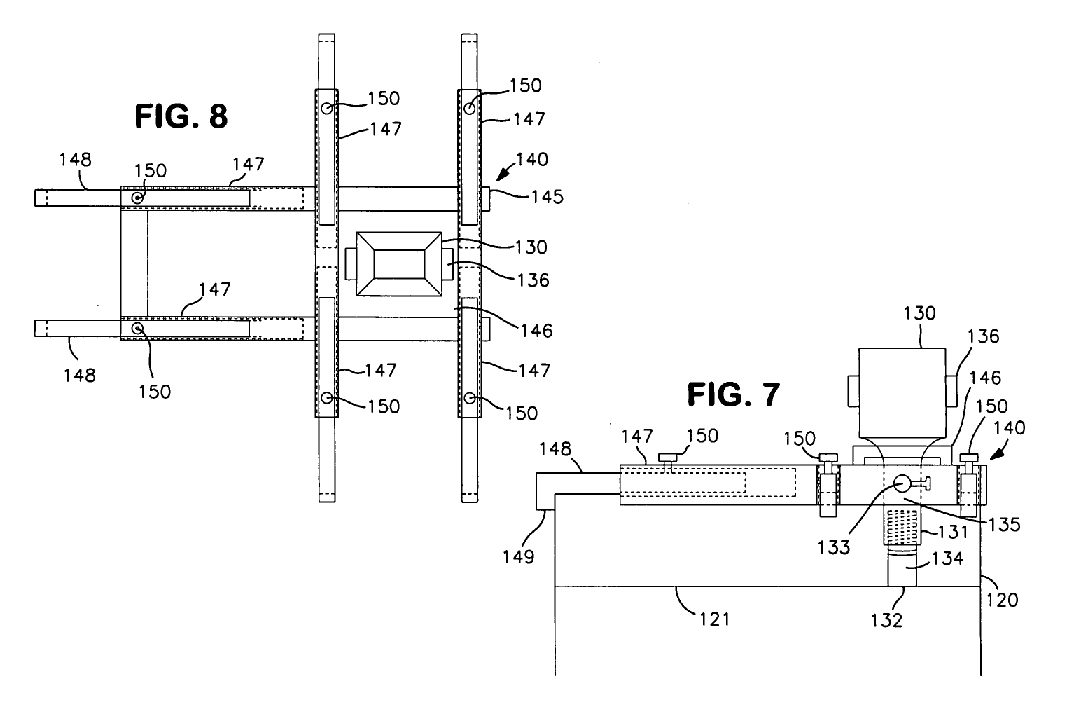

FIGS. 7-9 illustrate an alternate container and an alternate support of the present invention. FIG. 7 is a front cross-sectional view of the alternate container 130 and adjustable support 140 positioned over a dry filter tank 320. FIG. 8 is a top view of the container 130 and the support 140.

The container 130 comprising an extendable mouth portion 131 having a dispensing opening 132. The mouth portion 131 comprises a valve 133, a neck 135 and an adjustable water level pipe 134. The adjustable water level pipe 134 is adjustably connected to the distal portion of the neck 135. In this illustrated embodiment, the adjustability is provided by a threaded connection between the interior of neck 135 and the exterior of pipe 134. Alternatively, the water level pipe can be adjustably connected to the neck 135 in any known manner such as a sliding connection. This adjustable connection allows the height of the dispensing opening 132 to be easily adjusted relative to the support 140 or the top of tank 120. The container 130 also comprises handles 136 which facilitate placing and removing the container 130 from the dry filter tank 120 when the water supply of the container 130 requires replenishment.

The support 140 has adjustable arms to facilitate placement on tanks of different dimensions. The illustrated support 140 is laterally adjustable to the left, forwardly and rearwardly. The support 140 comprises a container support portion 146 and a plurality of substantially hollow arm portions 147. The container support portion 146 is shaped and dimensioned to receive a container 130.

As shown in FIG. 8, the plurality of adjustable arms comprise a pair of hollow arm portions 147 extending to the left of the container support portion 146 and a pair of arm portions 147 extending forwardly and rearwardly of the container support portion 146. Each of the substantially hollow arm portions 147 receive a portion of an adjustable arm extension 148 such that one end of the adjustable arm extension 148 extends outwardly from the arm portions 147. The ends of each adjustable arm extension 148 comprise a downwardly extending lip portion 149 which extends down a side of the tank 120.

According to this illustrated embodiment, the right side of the support 140 does not have adjustable arm extensions for laterally adjusting the support to the right. However, according to an alternative embodiment, the support is laterally adjustable in four different directions, namely, forwardly, rearwardly, to the left and to the right. The right side of the support of the embodiment illustrated in FIG. 8 also does not have downwardly extending lip portions. According to an alternative construction, the support includes downwardly extending lip portions on all four arm extensions. The downwardly extending lip portions are intended to provide stability and do not need to contact the sides of the tank.

The adjustable arms comprise locking screws 150 which are manually operable to releasably lock the adjustable arm extensions 148 in position relative to hollow arm 147 once the support is adjusted to the size of the tank. In an embodiment where the support is positioned over a fish tank, the portions of the support which are not holding the container comprise covers which are intended to cover the fish tank in order to reduce the rate of evaporation and to keep the fish in the fish tank.

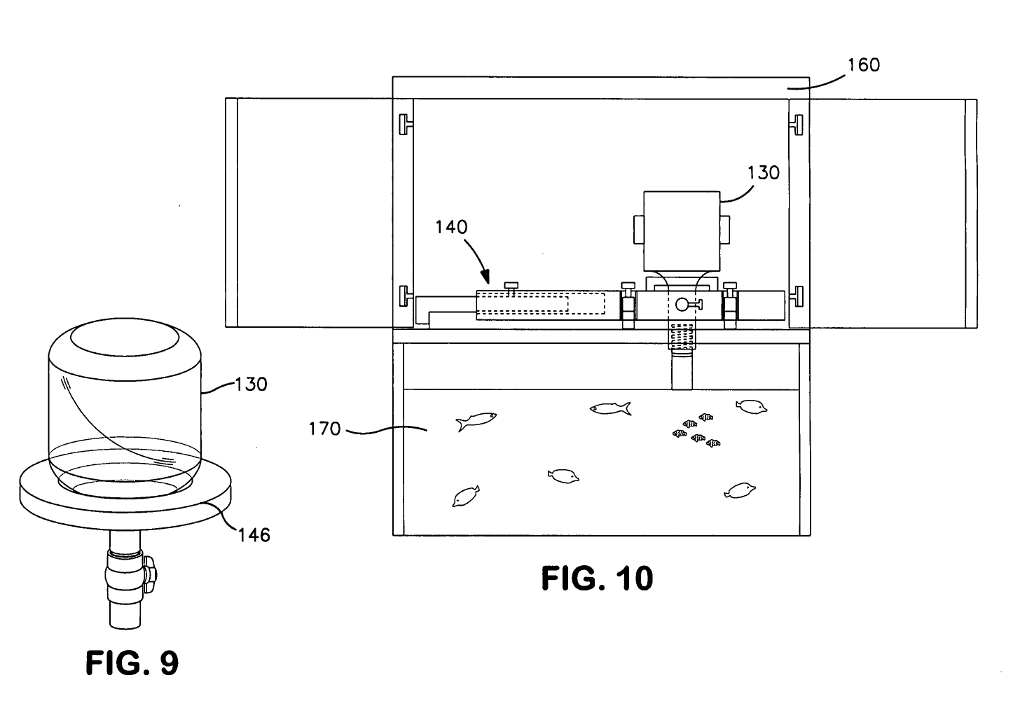

The support 140 is laterally adjustable in three different directions. Alternatively, the support can be laterally adjustable in at least two different directions. FIG. 9 is a perspective view of the container 130 positioned in the container support portion 146. The illustrated container support portion 146 is in the form of a round collar similar to a support used with some water coolers.

FIG. 10 illustrates the support 140 and container 130 illustrated in FIGS. 7-9 positioned within a housing 160 that is over a fish tank 170.

According to another embodiment of the present invention the apparatus comprises at least one container positioned directly on a dry filter tank or fish tank. In this embodiment, a support is not required. The container is positioned directly on the dry filter tank or fish tank. This embodiment is intended to be used in combination with a dry filter tank or a fish tank which does not have a completely open top and has some upper structures with sufficient strength to support the container in an inverted position.

Advantages of using the disclosed apparatus with a dry filter tank is that the disclosed apparatus keeps the water level in the dry filter tank constant. Maintaining a constant water level prevents the motor of the dry filter tank from burning out and also allows a filter in the dry filter tank to continue running properly. Use of the disclosed apparatus also allows other mechanisms used in conjunction with a fish tank and a dry filter tank, such as a water skimmer machine, to work properly and more efficiently due to the constant water level. The water level in the dry filter tank typically decreases due to evaporation, thereby requiring a user to be watchful of this decrease and maintain the appropriate water level in the dry filter tank. Water in the dry filter tank typically needs to be replenished every several days.

Use of the apparatus disclosed herein allows for extended periods of time to pass with little to no maintenance to maintain the water levels in a dry filter tank or fish tank.

1. An apparatus for maintaining a predetermined water level in a dry filter tank which comprises water and at least one opening, said apparatus used in combination with a dry filter tank, and said apparatus comprising:
at least one container for holding a supply of water, said container comprising a mouth portion having a dispensing opening;
said mouth portion comprising a valve, said valve is selectively operable to prevent or allow a flow of water from said dispensing opening; and
at least one support for supporting said container in an inverted position with said dispensing opening at least as low as said water level;
wherein said at least one container is positioned on said at least one support in an inverted position with said dispensing opening facing downwardly and said mouth portion extending at least partially into the at least one opening of the dry filter tank.

2. An apparatus according to claim 1 wherein said at least one support comprises at least one opening, a generally flat bottom surface, and a top surface.

3. An apparatus according to claim 2 wherein said top surface of said support comprises at least one positioning segment extending upwardly from said top surface.

4. An apparatus according to claim 3 wherein said at least one positioning segment is arranged proximate said at least one opening of said support.

5. An apparatus according to claim 2 wherein said top surface of said support comprises a plurality of positioning segments extending upwardly from said top surface and arranged proximate said at least one opening of said support.

6. An apparatus according to claim 5 wherein at least one of said plurality of positioning segments is beveled to contact a portion of said at least one container.

7. An apparatus according to claim 2 wherein said at least one container is positioned on said top surface of said support, and at least a portion of said generally flat surface of said support contacts the dry filter tank.

8. An apparatus according to claim 1 wherein said at least one support is a dual support.

9. An apparatus according to claim 1 wherein said at least one support is adjustable.

10. An apparatus according to claim 1 wherein said valve is in contact with the water level of the dry filter tank when said container is positioned on said at least one support.

11. An apparatus according to claim 1 wherein said support comprises a container support portion and a plurality of substantially hollow arm portions, wherein each of said plurality of hollow arm portions receive an adjustable arm extension comprising a first end and a second end, and wherein said first end of each of said adjustable arm extensions is received within one of said hollow arm portions and said second end of each of said adjustable arm extensions comprises a downwardly extending lip portion.

12. An apparatus according to claim 10 wherein said hollow arm portions comprise a locking screw for releasably locking said adjustable arm extensions to said hollow arm portions.

13. An apparatus according to claim 10 wherein each of said downwardly extending lip portions contact the dry filter tank and hold said support on the dry filter tank.

14. An apparatus according to claim 10 wherein said container support portion receives said container.

15. An apparatus according to claim 10 wherein said at least one support is adjustable.

16. An apparatus according to claim 1 wherein said apparatus and said dry filter tank are positioned within a housing.

17. An apparatus according to claim 1 wherein said valve is manually operable.

18. An apparatus for maintaining a predetermined water level in a dry filter tank which comprises water and at least one opening, said apparatus used in combination with a dry filter tank, and said apparatus comprising:
at least one container for holding a supply of water, said container comprising a mouth portion having a dispensing opening;
said mouth portion comprising a valve selectively operable to prevent or allow a flow of water from said dispensing opening;
wherein said at least one container is positioned on the dry filter tank in an inverted position with said dispensing opening facing downwardly and said mouth portion extending at least partially into the at least one opening of the dry filter tank.

19. An apparatus according to claim 18 wherein said dispensing opening is at least as low as said water level.

20. An apparatus according to claim 18 wherein said apparatus and said dry filter tank are positioned within a housing.

21. An apparatus according to claim 18 wherein said dispensing opening is at least as low as said water level of the dry filter tank.

22. An apparatus according to claim 18 wherein said mouth portion further comprises a neck and an adjustable water level pipe connected to said neck.

23. An apparatus according to claim 22 wherein said adjustable water level pipe is threadedly connected to said neck portion.

24. An apparatus according to claim 18 wherein said valve is manually operable.

25. An apparatus for maintaining a predetermined water level in a fish tank which comprises water and at least one opening, said apparatus used in combination with a fish tank, and said apparatus comprising:
at least one container for holding a supply of water, said container comprising a mouth portion;
said mouth portion comprising a valve and selectively operable to prevent or allow a flow of water from said dispensing opening; and
at least one support for supporting said container in an inverted position with said dispensing opening at least as low as said water level;
wherein said at least one container is positioned on said at least one support in an inverted position with said dispensing opening facing downwardly and said mouth portion extending at least partially into the at least one opening of the fish tank.

26. An apparatus according to claim 25 wherein said at least one container and said at least one support is positioned in a housing.

27. An apparatus according to claim 25 wherein said valve is manually operable.
